(19) United States
(12) Patent Application Publication
(10) Pub. No.: US 2026/0245162 A1
(43) Pub. Date: Aug. 20, 2026

(54) INFORMATION PROVIDING METHOD

(71) Applicant: TOYOTA JIDOSHA KABUSHIKI KAISHA, Toyota-shi (JP)

(72) Inventors: Yukiko SONOHARA, Obu-shi (JP); Hirofumi MORISHITA, Anjo-shi (JP)

(73) Assignee: TOYOTA JIDOSHA KABUSHIKI KAISHA, Toyota-shi (JP)

(21) Appl. No.: 19/403,949

(22) Filed: Nov. 30, 2025

(30) Foreign Application Priority Data
Feb. 17, 2025 (JP) 2025-023777

(51) Int. Cl. G06Q 50/18

(52) U.S. Cl. CPC G06Q 50/188

(57) ABSTRACT

The present disclosure relates to an information providing method that is executed by an information processing apparatus. The information providing method includes: acquiring evaluation information related to the likelihood of purchase in a plurality of business negotiations; and presenting the evaluation information for each of the business negotiations to a manager.

### CROSS-REFERENCE TO RELATED APPLICATION

This application claims priority to Japanese Patent Application No. 2025-023777 filed on February 17, 2025. The disclosure of the above-identified application, including the specification, drawings, and claims, is incorporated by reference herein in its entirety.

### BACKGROUND

### Technical Field

This disclosure relates to information providing methods.

### Description of Related Art

Techniques for analyzing the content of business negotiations related to products have been known in the art. For example, Japanese Unexamined Patent Application Publication No. 2019-28910 (JP 2019-28910 A) discloses a dialogue analysis system that checks whether, in a business negotiation with a customer, the sales representative has explained the matters that should be explained and has not mentioned the matters that should not be mentioned.

### SUMMARY

Although JP 2019-28910 A discloses a technique for analyzing the content of business negotiations by machine learning, supporting business negotiations by providing evaluation information related to a customer's likelihood of purchase has not been sufficiently explored. Thus, there has been room for improvement in technologies for supporting business negotiations.

In view of the foregoing circumstances, an object of the present disclosure is to improve technologies for supporting business negotiations by providing evaluation information related to a customer's likelihood of purchase.

An information providing method according to an embodiment of the present disclosure includes: acquiring evaluation information related to the likelihood of purchase in a plurality of business negotiations; and presenting the evaluation information for each of the business negotiations to a manager.

The embodiment of the present disclosure improves the technology for supporting business negotiations.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of a system according to an embodiment; and

FIG. 2 is a flowchart illustrating the operation of an information processing apparatus.

### DETAILED DESCRIPTION OF EMBODIMENTS

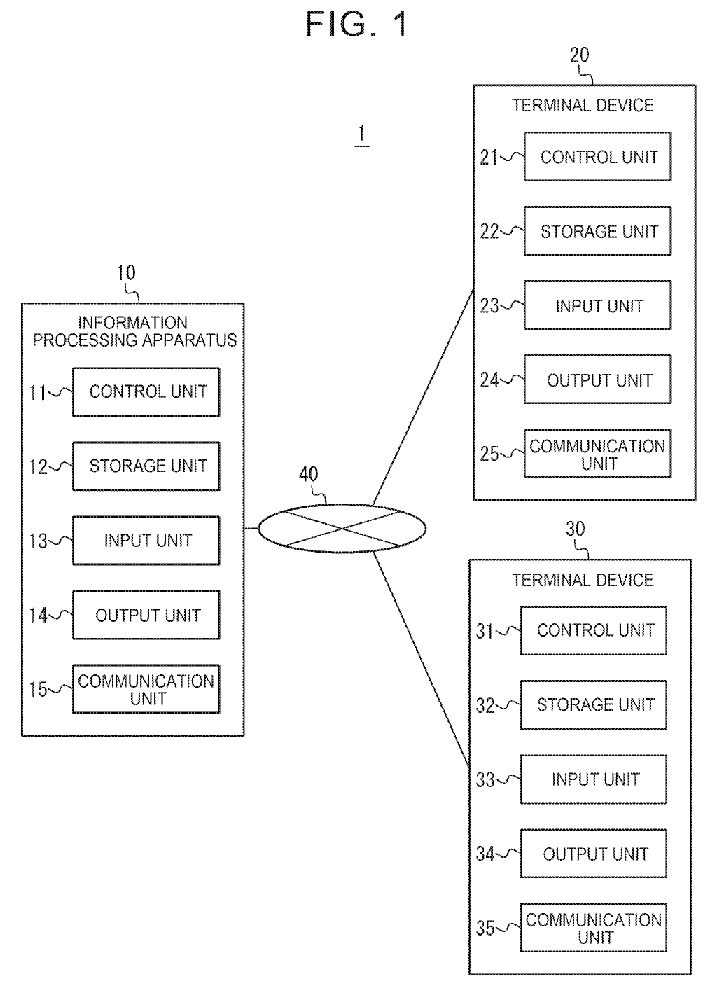

Hereinafter, an embodiment of the present disclosure will be described. The overview and configuration of a system 1 according to the present embodiment will be described with reference to FIG. 1. The system 1 according to the present embodiment includes an information processing apparatus 10, a terminal device 20, and a terminal device 30. The information processing apparatus 10 is, for example, a server device installed in a data center. The terminal device 20 is any device used by a user such as a staff member. The terminal device 30 is any device used by a user such as a manager who supervises staff. The information processing apparatus 10 and the terminal devices 20, 30 are communicably connected via a network 40 such as the Internet. Although one information processing apparatus 10, one terminal device 20, and one terminal device 30 are shown in FIG. 1, the system 1 may include two or more information processing apparatuses 10, two or more terminal devices 20, and two or more terminal devices 30.

First, the overview of the information providing method according to the present embodiment will be described, and details will be given later. In the present embodiment, a business negotiation refers to, for example, a business negotiation related to vehicle sales, in which the offering is a vehicle. However, the present disclosure is not limited to this. For example, a business negotiation may be a meeting intended to conclude various types of contracts, such as real estate transactions, insurance agreements, and financial product sales. In the present embodiment, the offering in a business negotiation may be a product, a service, digital content, a license, data or information, a financial product, real estate, an intangible asset, or any other tradable right. The information processing apparatus 10 according to the present embodiment acquires evaluation information related to the likelihood of purchase in multiple business negotiations. The multiple business negotiations may be, for example, negotiations being conducted simultaneously at the same store. The evaluation information related to the likelihood of purchase may include quantitative information such as a purchase likelihood score. The purchase likelihood score may be defined as, for example, a numerical value indicating the likelihood of purchase (e.g., 0% to 100%), a rank (e.g., 1 to 5), or a categorical classification (e.g., low, medium, or high). The evaluation information related to the likelihood of purchase may include qualitative information related to the likelihood of purchase. The qualitative information may include, for example, information related to the purpose of the customer's visit, past purchase history, vehicle models of interest, options, whether a test drive was taken, browsing history on websites, an estimated budget, and comparisons with competing vehicle models. The purpose of the customer's visit may include, for example, considering the purchase of a new vehicle, replacing a currently owned vehicle, consulting about repairs or maintenance, collecting information on vehicle models, booking a test drive, or participating in a specific campaign or event. The information processing apparatus 10 then presents to the manager the evaluation information related to the likelihood of purchase for each business negotiation.

As described above, in the present embodiment, the information processing apparatus 10 acquires evaluation information related to the likelihood of purchase in multiple business negotiations and presents the evaluation information to the manager. The manager can easily grasp the evaluation information related to the likelihood of purchase, and can therefore appropriately capture sales opportunities. The technology for supporting business negotiations is thus improved.

Next, the configurations of the information processing apparatus 10, the terminal device 20, and the terminal device 30 will be described in detail. As shown in FIG. 1, the information processing apparatus 10 includes a control unit 11, a storage unit 12, an input unit 13, an output unit 14, and a communication unit 15. The control unit 11 includes at least one processor. The processor is a general-purpose processor such as a central processing unit (CPU) or a dedicated processor specialized for specific processing. The control unit 11 controls the components of the information processing apparatus 10 and executes processing related to the operation of the information processing apparatus 10. The storage unit 12 includes at least one semiconductor memory etc. The semiconductor memory may be, for example, a random access memory (RAM) or a read-only memory (ROM). The storage unit 12 functions as, for example, a main storage device or an auxiliary storage device. The storage unit 12 stores data used for the operation of the information processing apparatus 10 and data obtained through the operation of the information processing apparatus 10. The input unit 13 includes at least one input interface. The input interface may be, for example, physical keys, a touchscreen, a sound sensor that receives voice input, or a camera that receives gesture input. The input unit 13 receives operations for entering data used in the operation of the information processing apparatus 10. The output unit 14 includes at least one output interface. The output interface may be, for example, a display that outputs visual information or a speaker that outputs audio information. The output unit 14 outputs data obtained through the operation of the information processing apparatus 10. The communication unit 15 includes at least one external communication interface. The communication interface may be either a wired communication interface or a wireless communication interface. In the case of wired communication, the communication interface may be, for example, a local area network (LAN) or a Universal Serial Bus (USB). In the case of wireless communication, the communication interface may be, for example, an interface that supports a mobile communication standard such as fifth generation (5G), or an interface that supports short-range wireless communication. The communication unit 15 receives data used for the operation of the information processing apparatus 10 and transmits data obtained through the operation of the information processing apparatus 10.

As shown in FIG. 1, the terminal device 20 includes a control unit 21, a storage unit 22, an input unit 23, an output unit 24, and a communication unit 25. The control unit 21 includes at least one processor. The processor is a general-purpose processor such as a CPU or a dedicated processor specialized for specific processing. The control unit 21 controls the components of the terminal device 20 and executes processing related to the operation of the terminal device 20. The storage unit 22 includes at least one semiconductor memory etc. The semiconductor memory may be, for example, a RAM or a ROM. The storage unit 22 functions as, for example, a main storage device or an auxiliary storage device. The storage unit 22 stores data used for the operation of the terminal device 20 and data obtained through the operation of the terminal device 20. The input unit 23 includes at least one input interface. The input interface may be, for example, physical keys, a touchscreen, a sound sensor that receives voice input, or a camera that receives gesture input. The input unit 23 receives operations for entering data used in the operation of the terminal device 20. The output unit 24 includes at least one output interface. The output interface may be, for example, a display that outputs visual information or a speaker that outputs audio information. The output unit 24 outputs data obtained through the operation of the terminal device 20. The communication unit 25 includes at least one external communication interface. The communication interface may be either a wired communication interface or a wireless communication interface. In the case of wired communication, the communication interface may be, for example, a LAN or a USB. In the case of wireless communication, the communication interface may be, for example, an interface that supports a mobile communication standard such as 5G, or an interface that supports short-range wireless communication. The communication unit 25 receives data used for the operation of the terminal device 20 and transmits data obtained through the operation of the terminal device 20.

As shown in FIG. 1, the terminal device 30 includes a control unit 31, a storage unit 32, an input unit 33, an output unit 34, and a communication unit 35. The control unit 31 includes at least one processor. The processor is a general-purpose processor such as a CPU or a dedicated processor specialized for specific processing. The control unit 31 controls the components of the terminal device 30 and executes processing related to the operation of the terminal device 30. The storage unit 32 includes at least one semiconductor memory etc. The semiconductor memory may be, for example, a RAM or a ROM. The storage unit 32 functions as, for example, a main storage device or an auxiliary storage device. The storage unit 32 stores data used for the operation of the terminal device 30 and data obtained through the operation of the terminal device 30. The input unit 33 includes at least one input interface. The input interface may be, for example, physical keys, a touchscreen, a sound sensor that receives voice input, or a camera that receives gesture input. The input unit 33 receives operations for entering data used in the operation of the terminal device 30. The output unit 34 includes at least one output interface. The output interface may be, for example, a display that outputs visual information or a speaker that outputs audio information. The output unit 34 outputs data obtained through the operation of the terminal device 30. The communication unit 35 includes at least one external communication interface. The communication interface may be either a wired communication interface or a wireless communication interface. In the case of wired communication, the communication interface may be, for example, a LAN or a USB. In the case of wireless communication, the communication interface may be, for example, an interface that supports a mobile communication standard such as 5G, or an interface that supports short-range wireless communication. The communication unit 35 receives data used for the operation of the terminal device 30 and transmits data obtained through the operation of the terminal device 30.

The functions of the information processing apparatus 10, the terminal device 20, or the terminal device 30 are implemented by executing a program according to the present embodiment with a processor corresponding to the control unit 11, the control unit 21, or the control unit 31. That is, the functions of the information processing apparatus 10, the terminal device 20, or the terminal device 30 are implemented by software. By executing the program that causes the computer to perform operations of the information processing apparatus 10, the terminal device 20, or the terminal device 30, the computer functions as the information processing apparatus 10, the terminal device 20, or the terminal device 30. In other words, the computer functions as the information processing apparatus 10, the terminal device 20, or the terminal device 30 by executing the operations of the information processing apparatus 10, the terminal device 20, or the terminal device 30 in accordance with the program. In the present embodiment, the program may be recorded on a computer-readable recording medium. The computer-readable recording medium includes a non-transitory computer-readable medium such as a magnetic recording device or a semiconductor memory. The program may be distributed by, for example, selling, transferring, or lending a portable recording medium such as a digital versatile disc (DVD) on which the program is recorded. Alternatively, the program may be distributed by storing the program in the storage of an external server and transmitting the program from the external server to another computer. The program may be provided as a program product. Part or all of the functions of the information processing apparatus 10, the terminal device 20, or the terminal device 30 may be implemented by a dedicated circuit corresponding to the control unit 11, the control unit 21, or the control unit 31. That is, part or all of the functions of the information processing apparatus 10, the terminal device 20, or the terminal device 30 may be implemented by hardware.

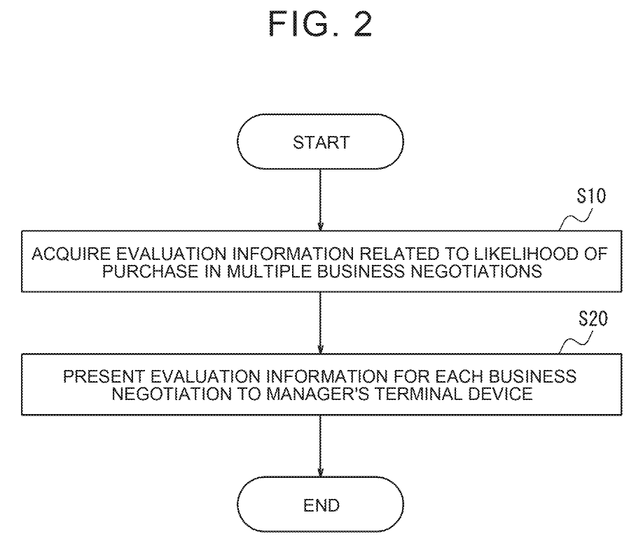

The operation of the information processing apparatus 10 according to the present embodiment will be described with reference to FIG. 2. First, the control unit 11 of the information processing apparatus 10 acquires evaluation information related to the likelihood of purchase in multiple business negotiations (S10).

Any method may be used for acquiring the evaluation information. For example, the evaluation information may be acquired from voice information obtained during a business negotiation. Any method may be used for acquiring the voice information. For example, the control unit 11 may acquire voice information from an external device such as the staff member's terminal device 20 via the communication unit 15 and the network 40. Alternatively, the control unit 11 may acquire voice information through, for example, the input unit 13. The control unit 11 may estimate evaluation information based on the voice information obtained during the business negotiation, and acquire the estimation result as the evaluation information. Any method may be used for the estimation. For example, the control unit 11 may input the voice information obtained during the business negotiation as explanatory variables into a trained model and estimate the evaluation information related to the likelihood of purchase as the output of the trained model. The trained model is a model created through machine learning using a machine learning algorithm. For example, the trained model may be a machine learning model constructed based on a decision tree, a model generated using a convolutional neural network (CNN), a recurrent neural network (RNN), or another machine learning algorithm such as deep learning.

The evaluation information may be acquired based on input information from a staff member involved in the business negotiation. For example, the evaluation information may be determined based on input information related to the business negotiation with the customer that has been entered into the staff member's terminal device 20. Such input information may include the customer's needs, desired conditions (such as vehicle model, options, and color), budget, preferred payment method, estimated timing of purchase, status of consideration of competing vehicle models, past visit history, whether a test drive was taken, interest in campaigns or special offers, questions asked by the customer, progress of the business negotiation, and likelihood of closing the deal. The control unit 11 may acquire the evaluation information based on these pieces of information.

The evaluation information may be estimated based on image information of the customer for each business negotiation. The image information includes still image information and moving image information. For example, the control unit 11 may acquire image information from an external device such as the staff member's terminal device 20 via the communication unit 15 and the network 40. Alternatively, the control unit 11 may acquire image information through, for example, the input unit 13. The control unit 11 may estimate evaluation information based on the image information obtained during the business negotiation, and acquire the estimation result as the evaluation information. Any method may be used for the estimation. For example, the control unit 11 may input the image information obtained during the business negotiation as explanatory variables into a trained model and estimate the evaluation information as the output of the trained model.

Next, the control unit 11 presents to the manager the evaluation information related to the likelihood of purchase for each business negotiation (S20). Any method may be used for presenting the evaluation information for each business negotiation. For example, the control unit 11 may transmit data to the manager's terminal device 30 via the communication unit 15, and present the evaluation information related to the likelihood of purchase through a user interface displayed by the output unit 34 of the terminal device 30. Alternatively, the control unit 11 may present the evaluation information related to the likelihood of purchase to the manager through a user interface displayed by the output unit 14.

As described above, in the present embodiment, the information processing apparatus 10 acquires evaluation information related to the likelihood of purchase in multiple business negotiations and presents the evaluation information to the manager. The manager can easily grasp the evaluation information related to the likelihood of purchase, and can therefore appropriately capture sales opportunities. The technology for supporting business negotiations is thus improved.

Although the present disclosure has been described with reference to the drawings and embodiment, it should be noted that various modifications and alterations may be made based on the present disclosure by those skilled in the art. Accordingly, such modifications and alterations are also included within the scope of the present disclosure. For example, the functions included in each component or step may be rearranged as long as no logical inconsistency arises, and two or more components or steps may be combined into one, or one component or step may be divided into separate components or steps.

For example, in S20, the control unit 11 of the information processing apparatus 10 may visually present the evaluation information related to the likelihood of purchase for each business negotiation by objects such as a heat map or icons in a virtual office that simulates the negotiation rooms. For example, the control unit 11 may highlight, by using a heat map or icons, the room corresponding to a business negotiation with a high likelihood of purchase. This makes it easier for the manager to visually identify which business negotiations to prioritize.

For example, the control unit 11 of the information processing apparatus 10 may determine, based on the evaluation information related to the likelihood of purchase for each business negotiation, which business negotiation the manager should join, and present that business negotiation to the manager. In this way, the manager can easily identify which business negotiation to join with higher priority among multiple business negotiations. For example, the business negotiation that the manager should join may be one in which the likelihood of purchase is greater than or equal to a first predetermined value (for example, 50%). When the likelihood of purchase is high, the manager joining the business negotiation may increase the probability of closing the deal. Alternatively, the business negotiation that the manager should join may be one in which the likelihood of purchase is less than a second predetermined value (for example, 90%). This is because, when the likelihood of purchase is extremely high, the deal can be closed even without the manager joining the business negotiation. The business negotiation that the manager should join may be determined based on the history information of the staff member in charge of the business negotiation. The history information of the staff member may include, for example, the staff member's past closing rate. For example, when the staff member has a low individual closing rate, the manager may be set to join that business negotiation with higher priority. On the other hand, when the staff member has a high individual closing rate, the priority to join that business negotiation may be lowered. Furthermore, the control unit 11 may determine the timing for the manager to join a business negotiation and present that timing. The timing for the manager to join a business negotiation may be determined based on the history information of the staff member in charge of the business negotiation. For example, when the staff member has a low individual closing rate, the manager may be set to join that business negotiation immediately. On the other hand, when the staff member has a high individual closing rate, the manager may be set to join that business negotiation at a later stage.

For example, when the control unit 11 of the information processing apparatus 10 estimates the evaluation information related to the likelihood of purchase based on voice information, the control unit 11 may calculate the accuracy of the estimation. The control unit 11 may output the evaluation information together with the calculated accuracy. In this way, the reliability of the evaluation information can be improved, allowing the user to make determinations while taking the accuracy of the evaluation information into account.

For example, in estimating the evaluation information related to the likelihood of purchase based on voice information, when the control unit 11 of the information processing apparatus 10 cannot estimate, within a predetermined period, the evaluation information related to the likelihood of purchase for each customer in multiple business negotiations with an accuracy higher than or equal to a predetermined level, the control unit 11 may present to the terminal device 20 information indicating that the likelihood of purchase for the corresponding negotiation is unknown (hereinafter also referred to as "suggestion information"). The predetermined period may be any desired length of time, for example, 30 minutes. The predetermined level of accuracy may be any desired probability, for example, 50%. In this way, when the evaluation information related to the likelihood of purchase remains unknown for the predetermined period of time or longer, the suggestion information is presented to the staff member's terminal device 20, thereby prompting the staff member to elicit the evaluation information related to the likelihood of purchase. The suggestion information may include a question for eliciting the evaluation information related to the likelihood of purchase. Including such a question makes it easier to obtain information from the customer.

For example, in the described embodiment, the configuration and operation of the information processing apparatus 10 may be distributed among a plurality of computers capable of communicating with each other.

What is claimed is:

1. An information providing method executed by an information processing apparatus, the method comprising:
acquiring evaluation information related to likelihood of purchase in a plurality of business negotiations; and
presenting the evaluation information for each of the business negotiations to a manager.

2. The information providing method according to claim 1, wherein the evaluation information is estimated based on voice information of each of the business negotiations.

3. The information providing method according to claim 1, wherein the evaluation information is acquired based on input from a staff member for each of the business negotiations.

4. The information providing method according to claim 1, wherein the evaluation information is estimated based on image information of a customer for each of the business negotiations.

5. The information providing method according to claim 1, further comprising determining, based on the evaluation information, the business negotiation to be joined by the manager, and presenting the business negotiation.
